(19) United States
(12) Patent Application Publication
(10) Pub. No.: US 2009/0091935 A1
(43) Pub. Date: Apr. 9, 2009

(54) LIGHT FIXTURE WITH AN EFFICIENCY-OPTIMIZED OPTICAL REFLECTION STRUCTURE

(76) Inventor: Hung-Yi Tsai, Taichung County (TW)

Correspondence Address: PAI PATENT & TRADEMARK LAW FIRM, 1001 FOURTH AVENUE, SUITE 3200, SEATTLE, WA, 98154, US

(21) Appl. No.: 12/247,217

(22) Filed: Oct. 7, 2008

(30) Foreign Application Priority Data
Oct. 8, 2007 (TW) 096216841

(51) Int. Cl. F21V 7/08; F21V 7/04

(52) U.S. Cl. 362/296.06; 362/296.05

(57) ABSTRACT

A light fixture with an optical reflection structure, comprising a lamp housing having at least one open accommodating space for light beam to be emitted outward therefrom; a plurality of connectors for coupling a light tube to the light fixture, the connectors being located at both opposite ends in a longitudinal direction of the accommodating space; a reflector having a curved surface affixed with a composite mirror film for light reflection, the reflector being located in the accommodating space and substantially covering at least a part of a surface of the accommodating space, wherein the curved surface is determined based on law of reflection by optimizing a luminous flux of primary reflection light reflected off the reflector to the extent of 90% or more compared with a naked light source from the light tube. The light fixture of the invention provides sufficient illumination and prolongs the lifespan of the light tube in a cost-economic way, thus directly saving energy and reducing the production of carbon.

### BACKGROUND OF THE INVENTION

a) Field of the Invention

The invention relates generally to a lighting structure, and more particularly, to a light fixture with an optical reflection structure for efficient illumination.

b) Description of the Related Art

The invention of lamps contributes a lot to the modern society. Realistically speaking, lighting apparatus (luminaire) has become essential to our daily lives today. In general, the conventional lighting apparatus 10 as shown in FIG. 1 includes a lamp housing 11 having an accommodating space 111, at least one light tube 12, and a reflex louver 13, in which the light tube 12 and the reflex louver 13 are disposed within the accommodating space 111 of the lamp housing 11, with the light tube 12 located between the lamp housing 11 and the reflex louver 13. However, according to optical reflection principle, conventional design of the lighting apparatus needs to be improved significantly in terms of the following points.

First, in the interior of the lamp housing 11, ineffective diffused light condenses due to the reflex louver 13, resulting in the so-called green house effect of the lamp housing 11 because of the temperature rise therein. Also, the temperature rise will inevitably ruin the structure of the luminaire so that the light tube and the internal circuits deteriorate acceleratively. The lighting apparatus therefore has an increased replacement rate of the light tube and the circuits.

Second, due to the reflex louver 13 as well, most of the light emitted from the light tube 12 cannot be reflected out of the lamp housing efficiently, leading to an insufficient light output for a desired illumination. In other words, the conventional lighting apparatus fails to achieve highest reflection efficiency. Accordingly, a relatively large percentage of light energy goes to waste when using the conventional lighting apparatus, which is diametrically opposed to the worldwide trend towards energy-saving and carbon-reduction policies.

In view of the above, the present inventor has been devoted to developing a light fixture with an efficiency-optimized optical reflection arrangement that provides more effective illumination to the surroundings.

### SUMMARY OF THE INVENTION

An object of the invention is to provide efficiency-optimized illumination at a minimized power consumption and energy costs. Another object of the invention is to prolong the lifespan of a lighting apparatus by providing an optimal output of reflective light, thereby reducing the level of greenhouse effect on the light space. Still another object of the invention is to provide a uniform output of reflective light by rapid focus adjustment.

In order to achieve the above objects, the invention provides a light fixture with a lamp housing having at least one open accommodating space for light beam to be emitted outward therefrom; a plurality of connectors for coupling a light tube to the light fixture, the connectors being located at opposite ends in a longitudinal direction of the accommodating space; a reflector with a curved surface to which a composite mirror film is affixed for light reflection, the reflector being located in the accommodating space and substantially covering at least a part of a surface of the accommodating space, wherein the curved surface is determined based on law of reflection by optimizing a luminous flux of primary reflection light reflected off the reflector to the extent of 90% or more compared with a naked light source from the light tube.

In one aspect of the invention, the composite mirror film is composed of five layers comprising a supporting layer; a principal reflection layer formed on the supporting layer; a transparent protection layer made from a non-metal based anti-reflection film and formed on the principal reflection layer; a thickening layer for a flexible adjustment in an overall thickness of the composite mirror film, the thickening layer being a bottom layer of the composite mirror layer; and an anaerobic hardening adhesive layer for bonding the supporting layer to the thickening layer. In another aspect of the invention, the composite mirror film is free of the supporting layer and thus composed of four layers.

In one aspect of the invention, there is provided the light fixture, in which the curved surface of the reflector possesses an approximately parabolic profile, an approximately semicircular profile, an approximately semi-elliptical profile, or a combination thereof. In another aspect of the invention, a light blocking sheet with a curved surface of an approximately semicircular profile is disposed adjacently to the connector.

Other aspects and advantages of the invention will become apparent from the following detailed description, taken in conjunction with the accompanying drawings, illustrating by way of example the principles of the invention.

### BRIEF DESCRIPTION OF THE DRAWINGS

The above and other objects, advantages and features of the invention will be more apparent from the following description of certain preferred embodiments taken in conjunction with the accompanying drawings, in which:

FIG. 1 is a two-dimensional view schematically illustrating the configuration of a conventional lighting apparatus as well as the light path therewithin.

FIG. 2 is a three-dimensional view illustrating the structure of the lighting apparatus according to the invention.

FIGS. 3A-3E are cross-section views each illustrating the position relationship between the light tube and the reflector, and the resultant reflective light paths.

FIGS. 4A-4B are cross-section views illustrating the constituent layers in sequence in two different types of the composite mirror films according to the invention.

FIGS. 5A-5C are cross-section views each illustrating the position relationship between the light tube and the reflector according to some representative aspects of the invention.

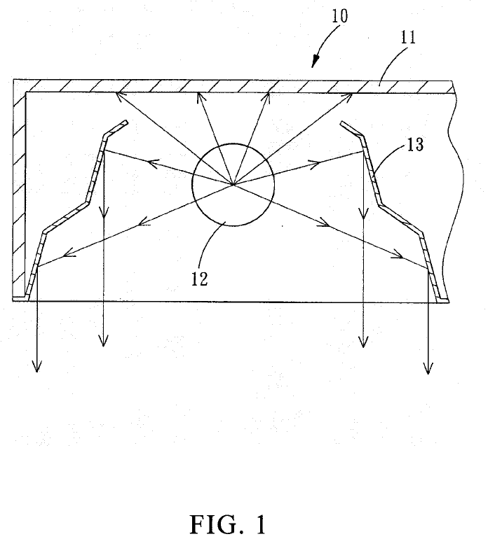

### DETAILED DESCRIPTION OF THE INVENTION

The invention will be described with reference to illustrative examples in the following. However, it should be understood by one of ordinary skill in the art that the invention may be practiced without some or all of these specific details. In other instance, well known process operations have not been depicted in detail in order not to unnecessarily obscure the invention.

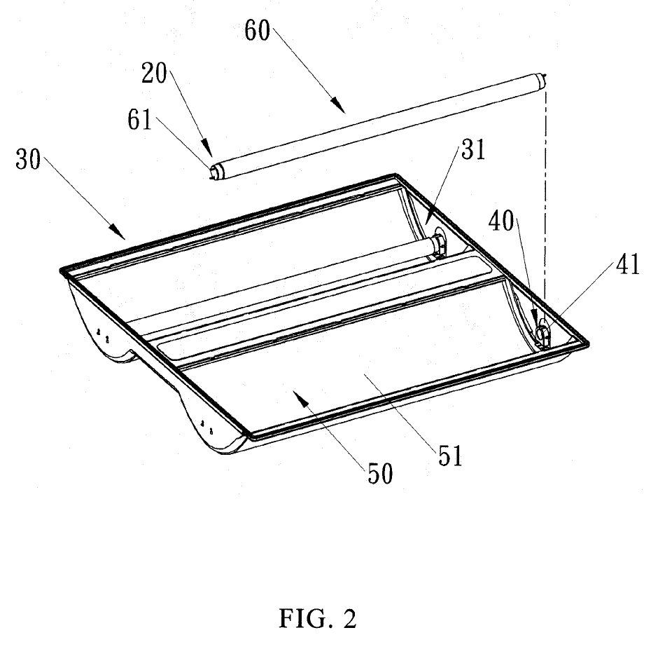

For example, FIG. 2 shows the lighting apparatus 20 of one aspect of the invention, which includes a lamp housing 30, four connectors 40, and two reflectors 50 each having a curved surface 51, wherein two light tubes 60 can be received in two open accommodating spaces 31 respectively by the connectors 40. The word “open” means that the accommodating space 31 provides a region for the light emitted from the light tube to “interact” with the surroundings and this should not be interpreted as a limiting condition. The lamp housing 30 may be made from, for example, aluminum or iron, or any other suitable materials. However, the number of the open accommodating spaces 31 in one lighting apparatus 20 may be determined as the case may be. For the convenience of illustration, two accommodating spaces 31 are distributed in parallel inside the lamp housing 30 in this example. It goes without saying that the other accommodating space 31 also has to be configured following the same way as mentioned above.

The lamp housing 30 may be integrally manufactured into one-piece by an injection molding technique, or it can be assembled by individually putting all the parts together or by any other suitable ways as long as a similar configuration can be acquired. By the way, the manufactured lamp housing 30 according to the invention preferably complies with the UL-94V0 standard.

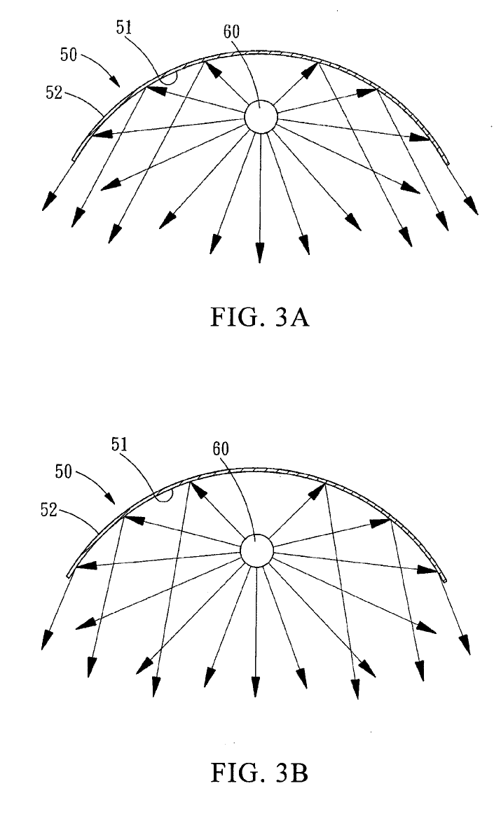

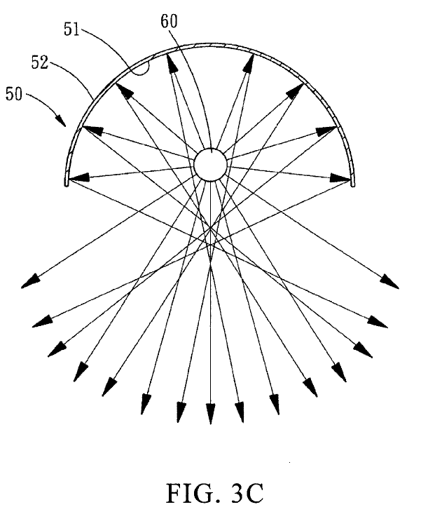

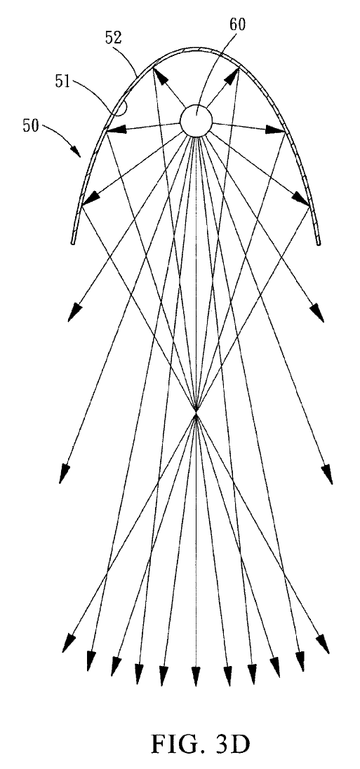

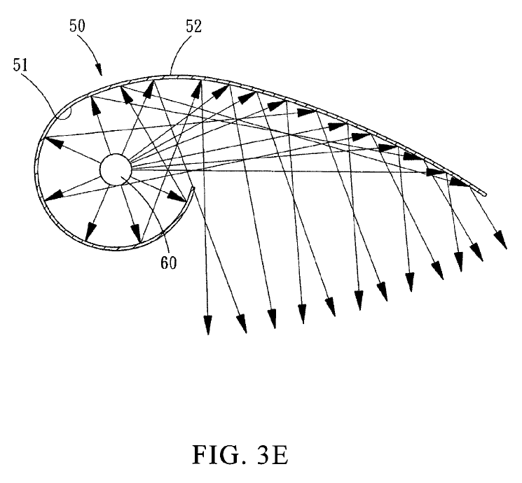

Connectors 40 are paired off and spaced apart from each other by a specified distance at the opposite ends in a longitudinal direction of the accommodating space 31. In FIG. 2, there are two connectors for one accommodating space for example. However, the number of the connectors 40 can be specified as desired. For a common light tube 60, there is a connecting part 61 as shown in FIG. 2 formed at both sides thereof. Therefore, each connector 40 is provided with one or more conjunction sites 41 for facilitating the coupling of the common light tube 60. The shapes and the locations of the conjunction sites 41 on the connector 40 may be designed appropriately matching with the shape of the connecting part 61 so that the vertical separation between the light tube 60 and the reflector 50 (or the composite mirror film 52) can be adjusted easily. Varying such a vertical separation can desirably manipulate the outward illumination area, as can be seen from FIGS. 3A and 3B described below.

It is well known that the reflector always plays a critical role in the design of a light fixture. The reflector 50 of the invention is housed in the accommodating space 31 as well and is configured to have a curved surface 51 possessing an approximately parabolic profile (FIGS. 3A and 3B), an approximately semi-circular profile (FIG. 3C), an approximately semi-elliptical profile (FIG. 3D), or a combination thereof (a “blend type” profile, FIG. 3E) or the like. Among others, FIG. 3A and 3B respectively show the schematic results for two different vertical separations between the light tube 60 and the reflector 50. To be specific, the reflector 50 of the invention is characterized by the aforementioned curved surface 51 affixed at least partly with a composite mirror film 52.

The profile of the curved surface 51 of the reflector 50 is determined based on law of reflection by optimizing a luminous flux of primary reflection light reflected off the reflector to the extent of 90% or more compared with a naked light source from the light tube. In detail, the total luminous flux of the light tube (surface source) to the surrounding is calculated by summing up the individual one of the numerous “point sources”. Then the curvature of the curve surface 51 is “trimmed” experimentally and empirically according to law of reflection (i.e. an angle of incidence is equal to an angle of reflection) to optimize the total luminous flux of primary reflection light. Specifically, part of the primary reflection light blocked by the light tube 60 itself should be reasonably excluded from the calculation of the luminous flux. On the contrary, the direct light from the light tube 60 should be taken into consideration. In summary, by using the light fixture according to the invention, the light output ratio defined as dividing the luminous flux of the reflected light from the curved surface 51 of the reflector 50 by the overall luminous flux of a naked light source can be optimized to be more than 90% that is hardly achieved by the conventional technology.

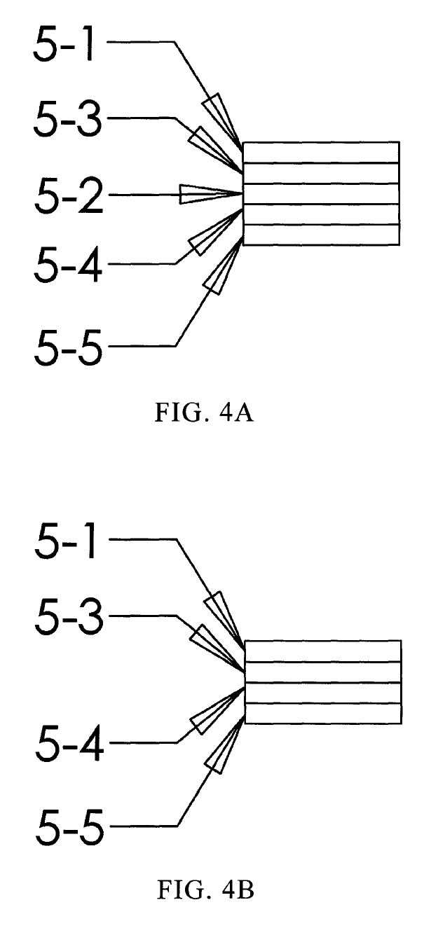

The composite mirror film 52 consists of four or five sequential layers. FIG. 4A is a cross-section view of the stacking order of the composite mirror film 52 comprising five layers. These five layers are in sequence the transparent protection layer (referred to as “the first layer” hereinafter) 5-1, the principal reflection layer (referred to as “the third layer” hereinafter) 5-3, the supporting layer (referred to as “the second layer” hereinafter) 5-2, the adhesive layer (referred to as “the fourth layer” hereinafter) 5-4, and the thickening layer (referred to as “the fifth layer” hereinafter) 5-5, as FIG. 4A shows.

The first layer 5-1 is formed by vacuum-evaporating a non-metal based anti-reflection film, laminating the anti-reflection film with polymethyl methacrylate (PMMA) or polyurethane (PU) preferably to a thickness of about 2-3 μm, then curing the laminated film via ultraviolet (UV) light. The vacuum evaporation process should be well known to a person of ordinary skill in the technology of manufacturing optical devices. In addition, a person of ordinary skill in this art understands that the anti-reflection film may be selected from the low-refractive material such as glass, an optical plastic, SiOx like SiO2 or SiO, titanium dioxide (TiO2), alkali metal fluoride like lithium fluoride (LiF), or alkali earth metal fluoride like magnesium fluoride (MgF2) or calcium fluoride (CaF2). In brief, the first layer 5-1 acts as a transparent shield protecting the composite mirror film 52 without causing any negative effect on light transmission.

The second layer serves as a supporting substrate and is formed by subjecting the film made from a suitable plastic material having a turbidity of 0.01 or less to a coiling process. The inventor found that an optical plastic with turbidity of 0.01 or less can meet the requirement of the invention as a good substrate candidate. The suitable optical plastic may be polyethylene terephthalate (PET), polycarbonate (PC) or polymethyl methacrylate (PMMA). More preferably, the thickness of the second layer may be controlled at about 20 μm. Among them, PMMA is preferred in terms of optical properties. It is to be noted that in another aspect of the invention, the composite mirror film 52 doesn't include the second layer (i.e. the supporting layer) 5-2, as shown in FIG. 4B.

The third layer, which is formed on the second layer, is made from pure metal (e.g., 99.99%) with a high reflectivity, such as aluminum, gold, silver, platinum or rhodium, using a vacuum evaporation process. Also, the third layer may be made from a nonmetal—TiO2, which has a high reflectivity within the visible region. However, a person of ordinary skill knows that a multi-layered film is formed when selecting TiO2 as the material of the third layer. Obviously, the third layer substantially serves as a reflective film. By the way, although there is no special bound to the thickness of the third layer, it is preferably in the range of several nanometers.

Referring to FIG. 4A, the second layer 5-2 is bond to the bottom layer (i.e. the fifth layer as will be described later) 5-5 via a thin anaerobic hardening adhesive 5-4 preferably with a thickness of 1-3 μm, 2 μm more preferably. This adhesive layer may be considered as the fourth layer contained in the composite mirror film 52. However, referring back to FIG. 4B, since the supporting layer 5-2 may be omitted in one aspect of the invention, the anaerobic hardening adhesive 5-4 is used to bond the third layer 5-3 rather than the second layer 5-2 to the bottom layer 5-5.

The integral thickness of the composite mirror film 52 is also a key factor in the illumination performance. The bottom layer of the composite mirror film 52, the fifth layer 5-5, is made from an optical plastic such as polyethylene terephthalate (PET), polycarbonate (PC) or polymethyl methacrylate (PMMA). It functions as a thickening film used for adjusting the integral thickness of the composite mirror film 52 to a desired level. In other words, the thickness of the composite mirror film 52 can reach a desired level by manipulating the thickness of the fifth layer. It is noted that attaching the fifth layer 5-5 to the second layer 5-2 or the third layer 5-3 via the fourth layer 5-4 will be the final step of preparing the composite mirror film 52.

As stated above, the vertical separation between the light tube 60 and the reflector 50 (or the curved surface 51) may be adjusted by engaging the connecting part of the light tube with different conjunction sites 41 of the connector 40. It is appreciated that a plurality of connectors 40 may be provided to the lamp housing 30 beforehand, and they may be positioned side by side, in a staggered manner, or in any other suitable form as needed.

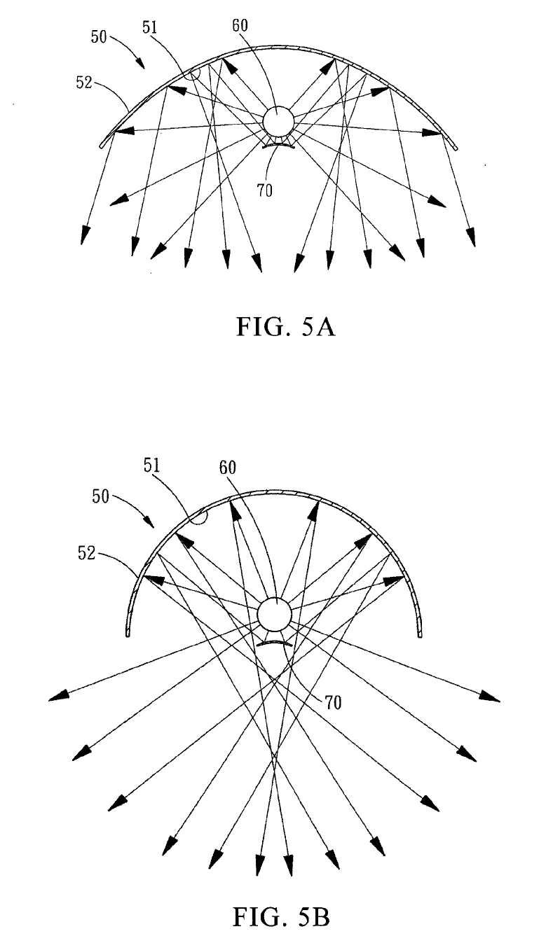

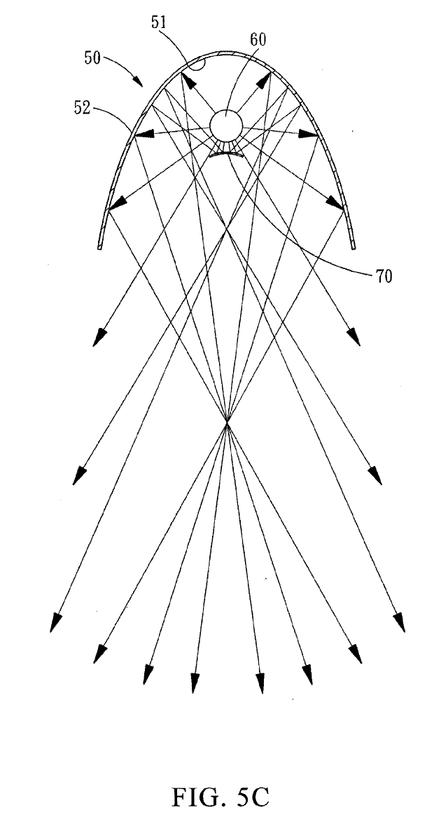

Similarly to FIGS. 3A-3E, FIGS. 5A-5C are cross-section views illustrating the position relationships between the lamp housing 30 and the reflector 50 of different curved surfaces and the resultant light reflections, except that a light blocking sheet 70 having a curved surface on the side facing the light tube 60 is provided to the lamp housing 30 at both sides thereof under the connector 40. The functions of the light blocking sheet 70 are, on one hand, making the user feel comfortable if directly viewing the light tube 60 unintentionally; on the other hand, primarily reflecting the direct light emitted from the light tube 60 so as to increase the total luminous flux. Accordingly, onto the curved surface of the light blocking sheet 70 facing the light tube 60, the composite mirror film 52 also has to be affixed. At the same time, the light blocking sheet 70 has a width equal to or slightly larger than the diameter of the light tube 60 in order to elaborate its functions.

For the light fixture of the invention, since the temperature around the accommodating space 31 can be maintained below 50° C. in practice, it is unnecessary to limit the material of the light blocking sheet 70 to a heat resistant one. For example, the material may be the same as that of the lamp housing. As well, there is no special limitation to either the profile of the curved surface of the light blocking sheet 70 or the vertical separation between the light tube 60 and the light blocking sheet 70. However, it is noted that the light blocking sheet 70 should have an upwardly convex profile for the surface facing the light tube 60 as shown in FIGS. 3A-3E, taking the effect of the primary reflection into consideration. Preferably, the light blocking sheet 70 may have the curved surface of an approximately parabolic profile, an approximately semicircular profile, an approximately semi-elliptical profile, or a combination thereof, similarly to the reflector 50 mentioned above.

Although the embodiments of the invention have been illustrated in the above, the invention is not limited to the aforementioned embodiments. Various equivalent changes and modifications can be made from the above embodiments without departing from the scope of the invention. All such changes and modifications as would be obvious to one of ordinary skill in the art are intended for inclusion within the scope of the invention.

What is claimed is:

1. A light fixture having an optical reflection structure, comprising:
a lamp housing having at least one open accommodating space for light beam to exit outside thereof;
a plurality of connectors for coupling a light tube to the light fixture, the connectors being located at both opposing ends in a longitudinal direction of the accommodating space;
a reflector having a curved surface attached with a composite mirror film for light reflection, the reflector being located in the accommodating space and substantially covering at least a part of a surface of the accommodating space, wherein
the curved surface is determined based on law of reflection by optimizing a luminous flux of primary reflection light reflected off the reflector to the extent of 90% or more compared with a naked light source from the light tube.

2. The light fixture according to claim 1, wherein the composite mirror film comprises:
a principal reflection layer;
a transparent protection layer made from a non-metal based anti-reflection film and formed on the principal reflection layer; and
a thickening layer for a flexible adjustment in an overall thickness of the composite mirror film, the thickening layer being at the bottom thereof,
wherein the principal reflection layer and the thickening layer are bonded with an anaerobic hardening adhesive.

3. The light fixture according to claim 1, wherein the composite mirror film comprises:
a supporting layer having a turbidity of 0.01 or less;
a principal reflection layer formed on the supporting layer;
a transparent protection layer made from a non-metal based anti-reflection film and formed on the principal reflection layer; and
a thickening layer for flexibly adjusting in an overall thickness of the composite mirror film, the thickening layer being at the bottom thereof,
wherein the supporting layer and the thickening layer are bonded with an anaerobic hardening adhesive.

4. The light fixture according to claim 2, wherein the transparent protection layer has a thickness of about 2-3 μm, and the anaerobic hardening adhesive layer has a thickness of 1-3 μm.

5. The light fixture according to claim 3, wherein the supporting layer has a thickness of about 20 μm, the transparent protection layer has a thickness of about 2-3 μm, and the anaerobic hardening adhesive layer having a thickness of 1-3 μm.

6. The light fixture according to claim 2, wherein the principal reflection layer is made from aluminum, gold, silver, or titanium dioxide (TiO2) by a vacuum evaporation process, the anti-reflection film is selected from the group consisting of SiOx, TiO2, an alkali metal fluoride, an alkali earth metal fluoride, glass, and a resin, and the thickening layer is made from an optical plastic.

7. The light fixture according to claim 3, wherein the supporting layer is made from an optical plastic and formed by a coiling process, the principal reflection layer is made from aluminum, gold, silver, or titanium dioxide (TiO2) by a vacuum evaporation process, the anti-reflection film is selected from the group consisting of SiOx, TiO2, an alkali metal fluoride, an alkali earth metal fluoride, glass, and a resin, and the thickening layer is made from an optical plastic.

8. The light fixture according to claim 4, wherein the principal reflection layer is made from aluminum, gold, silver, or titanium dioxide (TiO2) by a vacuum evaporation process, the anti-reflection film is selected from the group consisting of SiOx TiO2, an alkali metal fluoride, an alkali earth metal fluoride, glass, and a resin, and the thickening layer is made from an optical plastic.

9. The light fixture according to claim 5, wherein the supporting layer is made from an optical plastic and formed by a coiling process, the principal reflection layer is made from aluminum, gold, silver, or titanium dioxide (TiO2) by a vacuum evaporation process, the anti-reflection film is selected from the group consisting of SiOx, TiO2, an alkali metal fluoride, an alkali earth metal fluoride, glass, and a resin, and the thickening layer is made from an optical plastic

10. The light fixture according to claim 2, wherein the optical plastic from which the thickening layer is made is polyethylene terephthalate (PET), polycarbonate (PC) or polymethyl methacrylate (PMMA).

11. The light fixture according to claim 3, wherein the optical plastic from which the supporting layer is made is polyethylene terephthalate (PET), polycarbonate (PC) or polymethyl methacrylate (PMMA), and the optical plastic from which the thickening layer is made is polyethylene terephthalate (PET), polycarbonate (PC) or polymethyl methacrylate (PMMA).

12. The light fixture according to claim 8, wherein the transparent protection layer is formed by performing the steps of:
applying a vacuum evaporation treatment to the anti-reflection film having a thickness of ¼λ;
laminating the treated anti-reflection film with polymethyl methacrylate (PMMA) or polyurethane (PU); and
curing the laminated anti-reflection film with UV light.

13. The light fixture according to claim 9, wherein the transparent protection layer is formed by performing the steps of:
applying a vacuum evaporation treatment to the anti-reflection film having a thickness of ¼λ;
laminating the treated anti-reflection film with polymethyl methacrylate (PMMA) or polyurethane (PU); and
curing the laminated anti-reflection film with UV light.

14. The light fixture according to claim 1, wherein the lamp housing is made from a plastic, aluminum, or iron.

15. The light fixture according to claim 1, wherein the lamp housing is fabricated integrally into one piece using an injection molding technique.

16. The light fixture according to claim 1, wherein the curved surface of the reflector possesses an approximately parabolic profile, an approximately semi-circular profile, an approximately semi-elliptical profile, or a combination thereof.

17. The light fixture according to claim 1, wherein each of the connectors further comprises at least one set of conjunction sites for being engaged with the light tube, in which the set of the conjunction sites are located at different levels of the connector to facilitate manipulating the vertical separation of the light tube from the composite mirror film of the reflector.

18. The light fixture according to claim 1, further comprising a light blocking sheet with a curved surface affixed with the composite mirror film on the side facing the light tube, the light blocking sheet being located right under and spaced from the light tube and having a width substantially equal to or slightly larger than a diameter of the light tube, both ends of the light blocking sheet each being coupled to the lamp housing at a position in the neighborhood of and lower than the connector.

19. The light fixture according to claim 18, wherein the curved surface of the light blocking sheet has an approximately parabolic profile, an approximately semicircular profile, an approximately semi-elliptical profile, or a combination thereof.
